(19) United States
(12) Patent Application Publication
(10) Pub. No.: US 2007/0002874 A1
(43) Pub. Date: Jan. 4, 2007

(54) Method for distributing stream data based on multi-path scheme using tcp in real time

(76) Inventors: Yong-Il Kang, Seoul (KR); Sung-IL Kang, Gyeonggi-do (KR)

Correspondence Address: MAYER, BROWN, ROWE & MAW LLP, 1909 K STREET, N.W., WASHINGTON, DC, 20006, US

(21) Appl. No.: 10/587,213

(22) PCT Filed: Oct. 2, 2004
(86) PCT No.: PCT/KR04/02532

§ 371 Date: Jul. 25, 2006

(30) Foreign Application Priority Data
Oct. 2, 2003 (KR) 10-2003-0068892

(51) Int. Cl. H04L 12/56

(52) U.S. Cl. 370/401

(57) ABSTRACT

A method for distributing stream data based on a multi-path scheme using Transmission Control Protocol (TCP) and a computer-readable recording medium for storing a program that implements the method are disclosed. The method includes the steps of: requesting an input unit to transmit stream data; receiving the stream data generated in the input unit based on TCP scheme; assigning the received stream data to a specific channel; confirming a relay that requests stream data transmission of the specific channel; transmitting the stream data to one or more relays that request stream data transmission of the specific channel according to transmission control information of a controller; and receiving the stream data of the specific channel from one of neighboring relays.

### FIELD OF THE INVENTION

The present invention relates to a method for distributing stream data based on a multi-path scheme using Transmission Control Protocol (TCP) and a computer-readable recording medium for storing a program that implements the same method; and, more particularly, to a method for distributing stream data based on a multi-path scheme using Transmission Control Protocol (TCP), the method retransmits stream data generated in an input unit to a plurality of relays according to a control of a controller based on a multi-path scheme using TCP and a computer-readable recording medium for storing a program that implements the same method.

### DESCRIPTION OF RELATED ART

As a high-speed information and communication network is popularized and multimedia-related technology develops recently, the application field of multimedia contents becomes even wider. In particular, various audio/video distribution services are provided through public network broadcasting, satellite network broadcasting, cable network broadcasting and Internet broadcasting.

The audio/video distribution provided through Internet is utilized in various service fields, e.g., a Movies On Demand (MOD) service, a News On Demand (NOD) service, a user customized video catalog service, a remote monitoring and controlling service, a video conferencing service, a small office home office (SOHO) service and a tele-education service.

A network should transmit large-volume data in a high-speed transmission rate in order to provide a large-volume moving picture service without noticeable delay. However, the actual current network does not provide a sufficient environment to transmit the large-volume data without the delay.

Therefore, an application protocol standard for transmitting stream data in real-time is required, and the stream data is required to be transmitted in real-time better than to be transmitted reliably. Real-Time Protocol (RTP) based on User Datagram Protocol (UDP) has been adopted as the application protocol standard because UDP, which is non-reliable transmission protocol, causes less delay than Transmission Control Protocol (TCP).

In a service configuration, a video server transmits the moving picture to a neighboring relay server in real-time, and then the relay server retransmits the moving picture to each client in a method of broadcasting the moving picture such as television programs and movies to a subscriber in real-time.

FIG. 1 is a block diagram showing a communication network including a general video server and a general relay server.

As shown, the communication network provided with the general video server and the general relay server includes a plurality of clients 10, a relay server 20, a video server 30 and a multimedia database 40.

The client 10 has a multimedia player for displaying moving picture data. The relay server 20 retransmits stream data transmitted from the video server 30 to the client 10 after performing authentication, such as confirmation of a user identifier (ID) and a user password, in response to an order of the moving picture data from the client 10. The video server 30 converts moving picture data stored in the multimedia database 40 to stream data upon a request for the moving picture data from the relay server 20 and transmits the stream data to the relay server 20. The multimedia database 40 stores the moving picture data. Hereinafter, with reference to FIG. 2, a conventional process for distributing stream data in a communication network provided with a video server and a relay server will be described.

FIG. 2 is a block diagram showing a conventional process for distributing stream data.

As shown, a communication network includes a plurality of players 100, a plurality of relays 200A to 200C and a plurality of input units 300A and 300B.

The input units 300A and 300B are located in a contents provider and convert moving picture data such as a television program and a movie to stream data provided by the contents provider. The input units 300A and 300B convert moving picture data broadcasted in channels, e.g., a drama channel, a sports channel and an animation channel, into stream data of each channel. Also, the input units 300A and 300B transmit the stream data provided by the contents provider without conversion.

Then, the input units 300A and 300B transmit the generated stream data based on UDP to a neighboring relay 200A. Herein, the relays 200A to 200C requested the input units 300A and 300B to transmit the stream data in advance. The relay 200A transmits the stream data transmitted from input units 300A and 300B to another neighboring relay 200B based on UDP. The relay 200B transmits the stream data transmitted from the relay 200A to another neighboring relay 200C based on UDP.

As above, when the stream data generated in the input units 300A and 300B are transmitted to a plurality of relays 200A to 200C, each relay 200A to 200C receives requests for stream data transmission from neighboring players 100 and transmits the corresponding stream data to each player 100. Then, the player 100 receives the stream data and displays the moving picture of the channel to the user.

According to the conventional method as above, the stream data generated in the input units 300A and 300B are retransmitted to other neighboring relays 200A to 200C based on UDP.

Also, in the conventional method as above, the stream data are transmitted using Forward Error Correction (FEC) scheme or Automatic Repeat reQuest (ARQ) scheme additionally in order to compensate packet loss that can occur when the stream data of a UDP packet are transmitted. Therefore, there can be an overhead problem because the application should process the additional scheme for loss compensation beside the transmission protocol itself.

In addition, when the stream data is distributed based on RTP using UDP, multicasting function provided by network equipment is required, or a reliable network is required. It is hard to implement the method as above in the network which does not support the multicasting function as a whole as in the internet. Therefore, a more complex method or special network for distribution of stream data is required.

Also, in the conventional method, when a relay is broken down, the out-of-order relay cannot transmit the stream data generated in the input unit to neighboring relays. Thus, the players receiving the stream data from the out-of-order relay cannot receive the desired stream data until the relay is recovered.

### SUMMARY OF THE INVENTION

It is, therefore, an object of the present invention to provide a method for distributing stream data based on a multi-path scheme using Transmission Control Protocol (TCP), the method that retransmits stream data generated in an input unit to a plurality of relays based on a multi-path scheme of TCP and a computer-readable recording medium for storing a program that implements the method.

In accordance with one aspect of the present invention, there is provided a method for distributing stream data based on a multi-path scheme of transmission control protocol (TCP), the method including the steps of: requesting an input unit to transmit stream data; receiving the stream data generated in the input unit based on TCP scheme; assigning the received stream data to a specific channel; confirming a relay that requests stream data transmission of the specific channel; transmitting the stream data to one or more relays that request stream data transmission of the specific channel according to transmission control information of a controller; and receiving the stream data of the specific channel from one of neighboring relays.

In accordance with another aspect of the present invention, there is provided a method for distributing stream data based on a multi-path scheme of transmission control protocol (TCP), the method including the steps of: confirming that the stream data generated in the input unit are not transmitted; and requesting neighboring relays to transmit the stream data of the specific channel.

In accordance with another aspect of the present invention, there is provided a method for distributing stream data based on a multi-path scheme of transmission control protocol (TCP), the method including the steps of: receiving the stream data generated in the input unit from a plurality of relays; and releasing a connection with other relays except a neighboring relay with the fastest transmission rate among the relays according to transmission control information of the controller.

In accordance with another aspect of the present invention, there is provided a method for distributing stream data based on a multi-path scheme of transmission control protocol (TCP), the method including the steps of: receiving a request for the stream data transmission of the specific channel from a player; and transmitting the stream data to one or more players that make a request to transmit the stream data of the specific channel based on the TCP scheme according to transmission control information of a controller.

In accordance with one aspect of the present invention, there is provided a computer-readable recording medium for recording a program that implements a method for distributing stream data based on a multi-path scheme using Transmission Control Protocol (TCP) in a video on demand (VOD) system provided with a processor, the method including the steps of: requesting an input unit to transmit stream data; receiving the stream data generated in the input unit based on TCP scheme; assigning the received stream data to a specific channel; confirming a relay that requests stream data transmission of the specific channel; transmitting the stream data to one or more relays that request stream data transmission of the specific channel according to transmission control information of a controller; and receiving the stream data of the specific channel from one of neighboring relays.

In accordance with another aspect of the present invention, there is provided a computer-readable recording medium for recording a program that implements a method for distributing stream data based on a multi-path scheme using Transmission Control Protocol (TCP) in a video on demand (VOD) system provided with a processor, the method including the steps of: confirming that the stream data generated in the input unit are not transmitted; and requesting neighboring relays to transmit the stream data of the specific channel.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a communication network including a general video server and a general relay server;

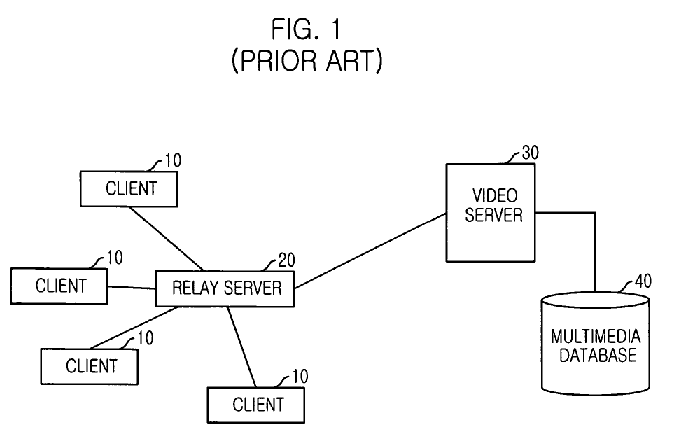

FIG. 2 is a block diagram showing a conventional process for distributing stream data;

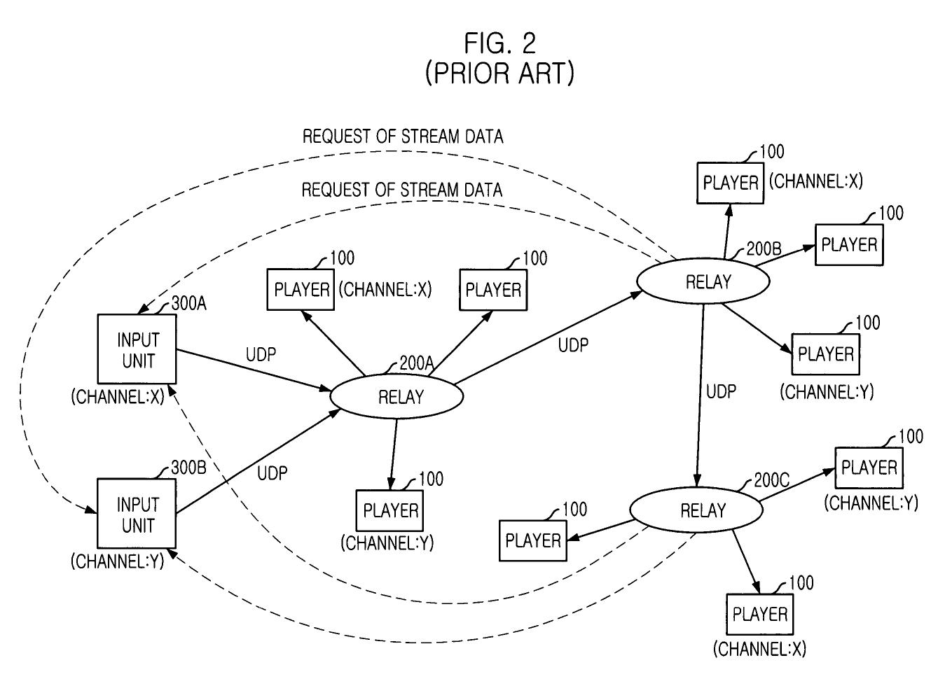

FIG. 3 is a block diagram showing a process for distributing stream data based on a multi-path scheme using transmission control protocol (TCP) in real time in accordance with a preferred embodiment of the present invention; and

FIG. 4 is a flowchart describing a method for distributing stream data based on a multi-path scheme using TCP in real time in accordance with a preferred embodiment of the present invention.

### DETAILED DESCRIPTION OF THE INVENTION

Hereinafter, a method for distributing stream data based on a multi-path scheme of transmission control protocol (TCP) will be described in detail with reference to the accompanying drawings.

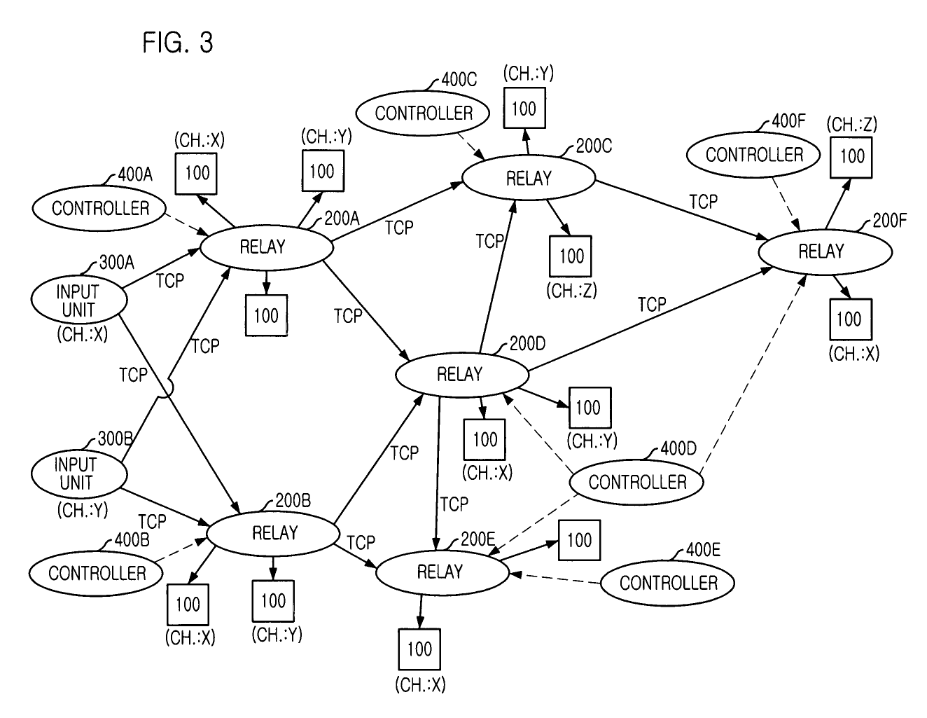

FIG. 3 is a block diagram showing a process for distributing stream data based on a multi-path scheme using Transmission Control Protocol (TCP) in accordance with a preferred embodiment of the present invention, wherein a dotted line indicates transmission of the control information, and a solid line indicates transmission of the data.

As shown, a communication network of the present invention includes a plurality of players 100, a plurality of relays 200A to 200E, a plurality of input units 300A and 300B and a plurality of controllers 400A to 400E.

The input units 300A and 300B convert moving picture data provided by a contents provider such as television programs and movies to stream data. Herein, the input units 300A and 300B utilize the moving picture or compress the moving picture data by using a codec to thereby generate stream data in form of a frame pack provided with multiple data frames and header information.

Then, the input units 300A and 300B transmit the generated stream data to neighboring relays 200A and 200B based on TCP. The relays 200A to 200F requested the input units 300A and 300B or neighboring relays 200A to 200F to transmit the stream data in advance.

The relays 200A and 200B transmit the stream data transmitted from the input units 300A and 300B to the other neighboring relays 200C to 200E based on TCP according to transmission control information of the controllers 400A to 400B. Herein, the controller 400A to 400E provides the transmission control information as changing a path, dividing a channel or merging channels based on TCP to the relays 200A to 200F, by monitoring a bit rate of the stream data and a state of the network.

Then, the relays 200C to 200E retransmit the stream data transmitted from the relays 200A and 200B to the neighboring relays 200C to 200F based on TCP according to the transmission control information of the controllers 400A to 400E. As above, when the stream data generated in the input units 300A and 300B are transmitted to the relays 200A to 200F, the relays 200A to 200F receive a request for stream data transmission, and then transmit the stream data to each player 100.

In response to the above, the player 100 divides the received stream data into the header information and frames, and displays the moving picture corresponding to the channel requested by the user by using the codec based on information of an input source.

In the present invention, the relays 200A to 200F retransmit the stream data by confirming other relays to transmit the stream data of the specific channel by using a routing table. Also, when each relay receives a request of the stream data transmission for a specific channel from other neighboring relays, each relay 200A to 200F stores information of the neighboring relays which request the stream data. Table 1 presents an example of a routing table stored in the relay.

TABLE 1

| Source | | Destination | Relay |
|---|---|---|---|
| channel | Output channel | relay address | port number |
| 100 | 200 | 192.168.0.4 | 1000 |
| 300 | 300 | 192.168.0.100 | 1001 |
| . . . | . . . | . . . | . . . |

Herein, as the relays 200A to 200F receives a transmission request for stream data broadcasted through a 100 channel of the neighboring player 100 from other relays, it transmits the stream data to a 1000 port of the relay whose Internet address is “192.168.0.4” that is a destination relay address of the requested stream data. The relay transmits the stream data through the 200 channel and the relay which has received the above stream data broadcasts the stream data through the 200 channel to the neighboring player 100. Therefore, the channel number can be changed during taking the stream data over relays.

Also, among the input units 300A and 300B, the relays 200A to 200F and the players 100, the stream data transmission and a request/response thereof are operated based on TCP.

Also, connections among the relays 200A to 200F can be generated indefinitely logically. Thus, when one of the relays 200A to 200F is controlled to receive stream data from a plurality of relays, the relay releases connections with other relays except the relay with the fastest transmission rate. As above, each relay checks whether the specific channel is inputted doubly and prevents the same stream data from being received over and over.

Also, when a relay is broken down and then is recovered, the relay requests other neighboring relays to retransmit the stream data and transmits the stream data transmitted from the neighboring relay 200A to 200F to a neighboring player 100.

Also, the stream data which is converted from the moving picture usually broadcasted in a frequency channel by the contents provider is transmitted to the relays 200A to 200F and the players 100 through a logical channel. The channel is a logical unit including the arbitrary number of sets of video/audio/data. A plurality of channels can be merged into a channel and one channel can again be divided as a plurality of channels. Because a plurality of videos can exist in one channel, each player 100 can display a plurality of windows on screen at the same time, and also the main window can be changed by selecting a desired channel.

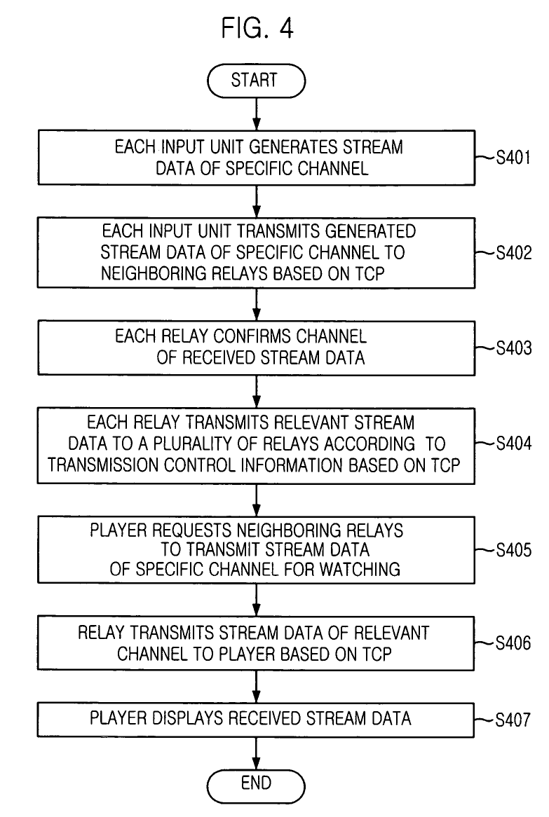

FIG. 4 is a flowchart describing a method for distributing stream data based on a multi-path scheme using TCP in accordance with a preferred embodiment of the present invention.

Each of the input units 300A to 300B generates stream data of a specific channel at step S401. Each of the input units 300A to 300B generates the stream data by converting moving picture data, e.g., drama and sports, broadcasted in a channel of a contents provider. Additionally, one input unit can generate stream data of a plurality of channels.

Then, the input units 300A and 300B transmit the generated stream data to neighboring relays 200A and 200B based on TCP at step S402. Herein, the input units 300A and 300B transmit TCP packets loading the stream data after TCP connections are established among the input units 300A and 300B and the neighboring relays 200A to 200F. As the response to the above, the neighboring relays 200A and 200B acknowledges the reception of the stream data. Therefore, stream data loss can be prevented by using TCP.

Then, the relays 200A and 200B confirm channels of the received stream data at step S403. The relays 200A and 200B determine the kind of broadcasting service based on the channels of the stream data.

Then, the relays 200A and 200B transmit the stream data to other neighboring relays and the players that request the stream data transmission of the corresponding channel based on TCP at step S404. The relays 200A and 200B confirm other relays that will receive the stream data of the specific channels based on the routing table and transmit the stream data to the corresponding relays. Also, the relays 200C to 200F which received the stream data from the relay 200A and 200B retransmit the stream data to other neighboring relays requesting a specific channel based on TCP.

Then, the player 100 requests the neighboring relays 200A to 200F to transmit the stream data of the desired channel for watching at step S405.

Then, the relays 200A to 200F transmit the stream data of the channel to the player 100 based on TCP at step S406.

Therefore, the player 100 displays the received stream data at step S407.

As above-mentioned, the method of the present invention can be embodied as a program and stored in a computer-readable recording medium, such as CD-ROM, RAM, floppy disk, hard disk, magneto-optical disk and the like. The process as above will not be described because it can be embodied by one of ordinary skill in the art.

The present invention can transmit stream data to players without noticeable delay and data loss by retransmitting stream data generated in the input unit to a plurality of relays based on a multi-path scheme using TCP. Therefore, the players can display the moving picture without irregular stopped screens in real time.

Also, because each relay makes a request to a plurality of the relays to transmit the stream data and also transmits the stream data to a plurality of the relays based on a multi-path scheme of TCP according to the present invention, the player can receive the stream data from other relays and display the moving picture without a service stop problem even though one relay is broken.

The conventional method that distributes the stream data using RTP based on UDP uses additional methods for increasing reliability. However, the additional methods occurs system load. In the other hand, the present invention can provide reliable data in real-time without using additional methods by distributing the stream data based on TCP.

The conventional method requires a network support of an IP level for multipoint distribution. In the other hand, the present invention can be implemented independent of the network support by embodying the method for distributing the stream data at an application level.

While the present invention has been described with respect to certain preferred embodiments, it will be apparent to those skilled in the art that various changes and modifications may be made without departing from the scope of the invention as defined in the following claims.

What is claimed is:

1. A method for distributing stream data based on a multi-path scheme using Transmission Control Protocol (TCP), the method comprising the steps of:
a) requesting an input unit to transmit stream data;
b) receiving the stream data generated in the input unit based on TCP scheme;
c) assigning the received stream data to a specific channel;
d) confirming a relay that requests stream data transmission of the specific channel;
e) transmitting the stream data to one or more relays that request stream data transmission of the specific channel according to transmission control information of a controller; and
f) receiving the stream data of the specific channel from one of neighboring relays.

2. The method as recited in claim 1, further comprising the steps of:
g) confirming that the stream data generated in the input unit are not transmitted; and
h) requesting neighboring relays to transmit the stream data of the specific channel.

3. The method as recited in claim 1, further comprising the steps of:
i) receiving the stream data generated in the input unit from a plurality of relays; and
j) releasing a connection with other relays except a neighboring relay with the fastest transmission rate among the relays according to transmission control information of the controller.

4. The method as recited in claim 1, further comprising the steps of:
k) receiving a request for the stream data transmission of the specific channel from a player; and
l) transmitting the stream data to one or more players that make a request to transmit the stream data of the specific channel based on the TCP scheme according to transmission control information of a controller.

5. The method as recited in claim 1, wherein in the step d), an internet address of the relay that makes a request to transmit the stream data to the specific channel is confirmed using a routing table storing information of the one or more relays that make a request to transmit the stream data of the specific channel.

6. The method as recited in claim 1, wherein the input unit compresses moving picture data provided by a contents provider and generates stream data in form of a frame pack including frames and header information of the compressed moving picture data.

7. The method as recited in claim 1, wherein the controller provides the transmission control information such as changing a path, dividing a channel or merging channels to the relay based on the TCP scheme while monitoring the bit rate of the stream data and the network states.

8. A computer-readable recording medium for recording a program that implements a method for distributing stream data based on a multi-path scheme using Transmission Control Protocol (TCP) in a video-on-demand (VOD) system provided with a processor, the method comprising the steps of:
a) requesting an input unit to transmit stream data;
b) receiving the stream data generated in the input unit based on TCP scheme;
c) assigning the received stream data to a specific channel;
d) confirming a relay that makes a request to transmit stream data to the specific channel;
e) transmitting the stream data to one or more relays that request stream data transmission of the specific channel according to transmission control information of a controller; and
f) receiving the stream data of the specific channel from one of neighboring relays.

9. The computer-readable recording medium as recited in claim 8, the method further comprising the steps of:
g) confirming that the stream data generated in the input unit are not transmitted; and
h) requesting neighboring relays to transmit the stream data of the specific channel.

10. The computer-readable recording medium as recited in claim 8, the method further comprising the steps of:
i) receiving the stream data generated in the input unit from a plurality of relays; and
j) releasing connections with other relays except a neighboring relay with the fastest transmission rate among the relays according to transmission control information of the controller.

11. The computer-readable recording medium as recited in claim 8, the method further comprising the steps of:
k) receiving a request of the stream data transmission to the specific channel from a player; and
l) transmitting the stream data to one or more players that make a request to transmit the stream data of the specific channel based on TCP scheme according to transmission control information of a controller.
